(19) United States
(12) Patent Application Publication
(10) Pub. No.: US 2010/0222909 A1
(43) Pub. Date: Sep. 2, 2010

(54) COLLABORATION WORK SYSTEM

(76) Inventors: Yoshito Ohtake, Tochigi (JP); Hiroshi Miwa, Tochigi (JP); Tetsuya Ozawa, Tochig (JP); Tatsuhiko Yamamoto, Tochigi (JP); Kenichi Ohno, Tochigi (JP); Ken Mura, Tokyo (JP); Jun Hikoe, Tokyo (JP); Kouji Ootsuki, Tokyo (JP); Masahiko Nagata, Tokyo (JP)

Correspondence Address: ARENT FOX LLP, 1050 CONNECTICUT AVENUE, N.W., SUITE 400, WASHINGTON, DC, 20036, US

(21) Appl. No.: 12/159,339

(22) PCT Filed: Feb. 8, 2006
(86) PCT No.: PCT/JP2006/302150

§ 371 Date: Jul. 17, 2008

(30) Foreign Application Priority Data
Dec. 26, 2005 (JP) 2005-371237

(51) Int. Cl. G06F 19/00

(52) U.S. Cl. 700/100; 901/50

(57) ABSTRACT

Work is performed in cooperation in a common region by a plurality of apparatuses and a human being, and at this time, human resources are used effectively, and the work is performed efficiently. When components A, B and C are processed by three apparatuses a, b and c and one person in, in the first process, the component A is processed by the person m, and the components B and C are processed by the two apparatuses b and c. In the second process, the component B is processed by the person in, and the components A and C are processed by the two apparatuses a and c. In the third process, the component C is processed by the person m, and the components A and B are processed by the two apparatuses a and b. The timings at which the person m intervenes in the respective apparatuses are prevented from overlapping in this manner, by which the work is performed efficiently.

### TECHNICAL FIELD

The present invention relates to a technique in which a plurality of apparatuses and human beings perform collaboration work, and at this time, the work efficiency is enhanced to the maximum.

### BACKGROUND ART

Conventionally, a technique in which a plurality of robots perform work simultaneously in a common region has been known. As a technique for shortening the time of teaching such robots to permit earlier start of robot work, for example, a robot system has been known in which a plurality of teaching persons corresponding to the number of robots use respective portable operation panels and are stationed near the respective robots in a common region, and also robot teaching is performed by providing safeguard equipment such as safety fences between the robots (for example, refer to Patent Document 1).

Patent Document 1: Japanese Patent Laid-Open No. 2003-340756

In the case of the above-described system, since the robot performs work without the intervention of person, prior teaching is needed. If the robot performs work without the intervention of person, the change in situation, the failure of robot, and the like cannot be coped with properly in some cases. Therefore, it is desirable that a person perform work together.

On the other hand, in order for the robot and person to work in a common region, it is necessary to reduce the number of persons as far as possible to effectively use human resources. Also, it is necessary to efficiently perform work.

### DISCLOSURE OF THE INVENTION

Accordingly, an object of the present invention is to provide a collaboration work system in which a plurality of apparatuses and human beings perform work in a common region, and at this time, human resources are used effectively and work is performed efficiently.

To achieve the above object, the present invention provides a collaboration work system in which a human being intervenes in at least a part of work performed by a plurality of apparatuses respectively, wherein the timings at which one person intervenes in the plurality of apparatuses are set to be prevented from overlapping, so that the work is performed simultaneously by the plurality of apparatuses and at least one person.

In the present invention, in performing predetermined processing on a plurality of components by the plurality of processing apparatuses capable of performing a processing job consisting of a plurality of processes, the processing job performed by the human being is included in a part of processing of the plurality of components, and during the time when a predetermined component is processed by a person, other components are processed by the processing apparatuses. By repeating this operation for each component, the work performed by the person and the work performed by the processing apparatus are prevented from overlapping on one component.

The timings at which a person intervenes in the plurality of processing apparatuses are set to be prevented from overlapping in this manner, and work is performed simultaneously so as to prevent the work performed by the person and the work performed by the processing apparatus from overlapping. Thereby, a waste such that many persons are stationed can be eliminated, and moreover the whole work can be accomplished with extremely high efficiency.

The apparatus may be a moving processing apparatus or a fixed processing apparatus.

A work system in which a person intervenes in at least a part of work performed by a plurality of apparatuses respectively is configured, and one person or a plurality of persons perform collaboration work together with the processing apparatuses by setting the intervention timings to be prevented from overlapping, by which the whole work can be performed efficiently.

### BRIEF DESCRIPTION OF THE DRAWINGS

FIGS. 1(a) to 1(c) are explanatory views showing one example of a collaboration work system in accordance with an embodiment of the present invention, being viewed from above;

FIG. 2 is an explanatory diagram showing a work share on the time axis;

FIG. 3 is an explanatory view showing another example of a collaboration work system in accordance with an embodiment of the present invention, being viewed from above;

FIG. 4 is an explanatory view showing one example of a collaboration work system in accordance with another embodiment of the present invention; and

FIG. 5 is an explanatory diagram showing a work share on the time axis for the collaboration work system shown in FIG. 4.

### BEST MODE FOR CALVING OUT THE INVENTION

Embodiments of the present invention will now be described with reference to the accompanying drawings.

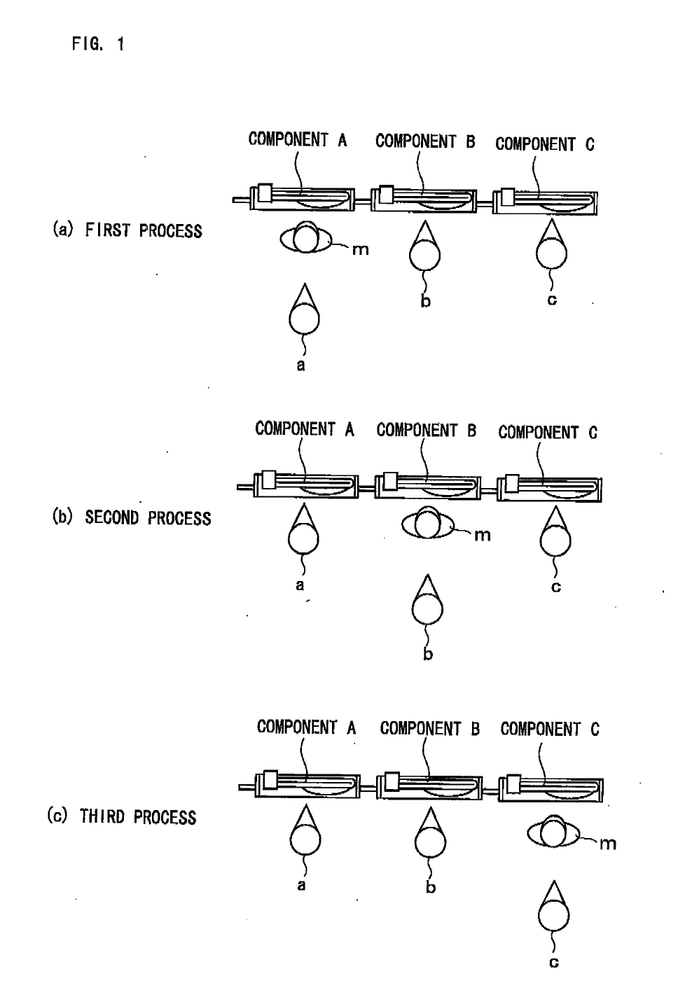

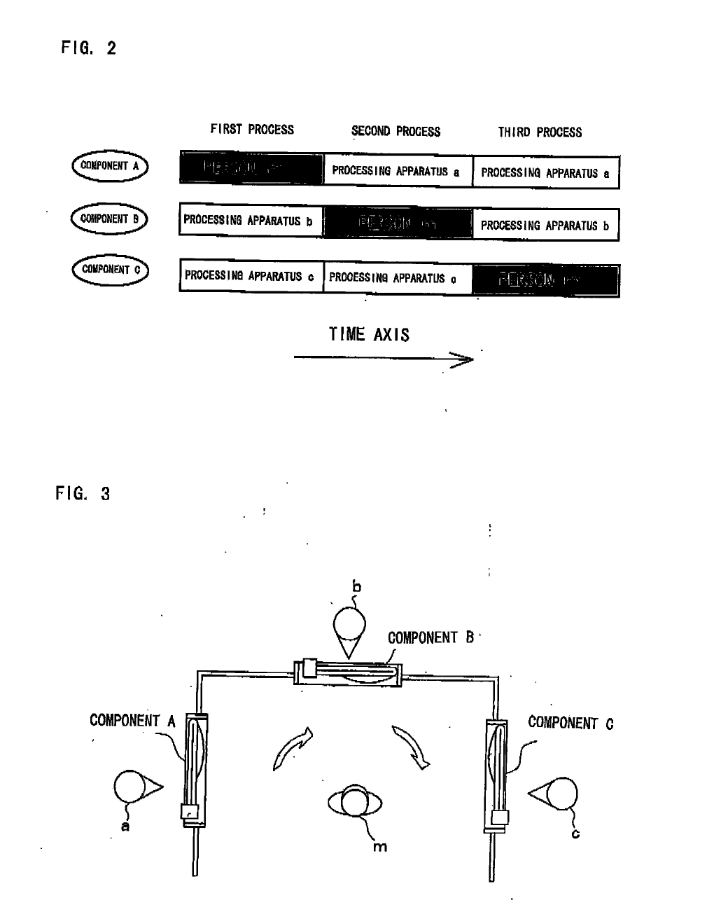

FIG. 1 is explanatory views showing one example of a collaboration work system in accordance with an embodiment of the present invention, being viewed from above. FIG. 2 is an explanatory diagram showing a work share on the time axis. FIG. 3 is an explanatory view showing another example of the collaboration work system, being viewed from above.

The collaboration work system of a plurality of apparatuses and a person in accordance with the present invention is configured as a system in which the movement of person is not restricted by the movement of apparatuses, and work can be performed efficiently. In this description, for ease of explanation, a case where, for example, components A, B and C are processed in three processes, and of these three processes, two processes provide processing performed by moving apparatuses a, b and c, and one process provides processing performed by a person m is explained as an example.

For example, the components A, B and C are the same components, and these components A, B and C are processed three times. However, they are not processed at the same timing, but are processed three times at different timing. Of these three processing jobs, one processing job is performed by the person m, and the remaining two processing jobs are performed by the moving apparatuses a, b and c.

In this case, in the first process, as shown in FIGS. 1(a) and 2, of the components A, B and C on a processing line, the component A is processed by the person m, and during this time, the components B and C are processed by the two apparatuses b and c.

Then, in the second process, as shown in FIGS. 1(b) and 2, the component B is processed by the person m, and during this time, the components A and C are processed by the two apparatuses a and c.

In the subsequent third process, as shown in FIGS. 1(c) and 2, the component C is processed by the person m, and during this time, the components A and B are processed by the two apparatuses a and c. In this embodiment, the processing jobs of all of the components A, B and C are finished by the first to third processes.

By the above-described procedure, in the collaboration work with the apparatuses a, b and c that requires the intervention by the person m in at least a part of processing, the timings at which the person m intervenes in the respective apparatuses do not overlap, so that wasteful time is eliminated. Therefore, the whole work can be accomplished efficiently.

In the above-described embodiment, the case where the processing line is straight. However, as shown in FIG. 3, the processing line may be such that a processing section is formed so as to surround the person m to decrease the movement distance of the person m. Needless to say, the timings at which the person m intervenes in the apparatuses a, b and c in this case are the same as shown in FIG. 2.

Also, in the above-described embodiment, the example in which the components A, B and C are processed is shown. However, the processing job includes work other than mechanical processing. Also, the apparatuses a, b and c need not be moving apparatuses, and may be fixed apparatuses. Further, the number of persons m is not limited to one. If a plurality of persons m are stationed, the overlap of work with other persons is avoided.

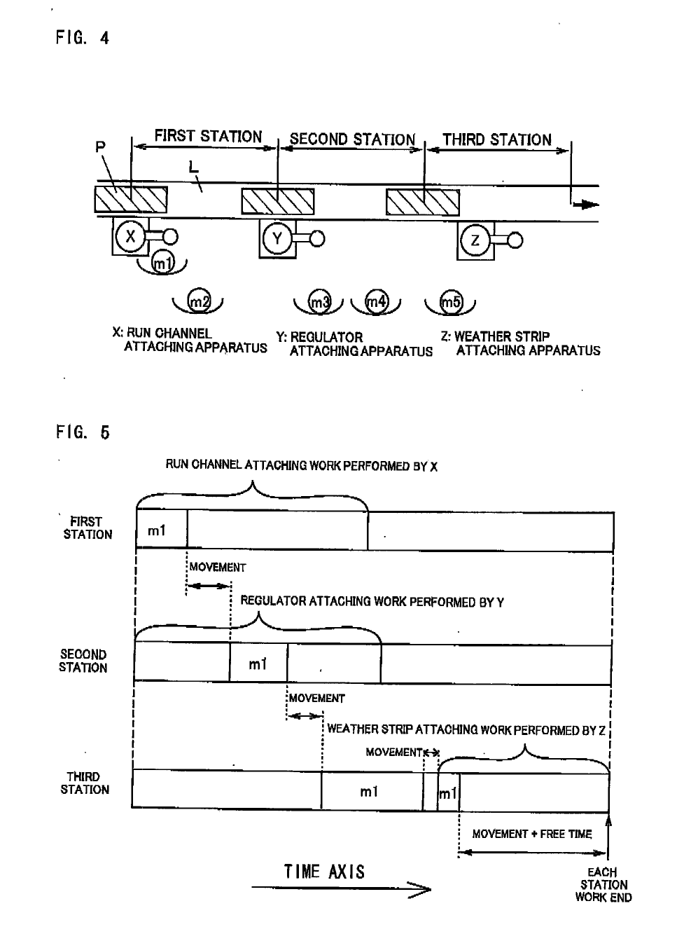

FIG. 4 is an explanatory view showing one example of a collaboration work system in accordance with another embodiment, and FIG. 5 is an explanatory diagram showing a work share on the time axis for the collaboration work system shown in FIG. 4. In an example of this embodiment, along an assembly/conveyance line L for a pallet P mounted with a vehicular door, a first station at which a run channel attaching apparatus X is disposed, a second station at which a regulator attaching apparatus Y is disposed, and a third station at which a weather strip attaching apparatus Z is disposed are provided.

On the other hand, as workers, five persons m1, m2, m3, m4 and m5 are stationed. Of these workers, the worker nil is engaged in the work at all stations, and other workers m2, m3, m4 and m5 are engaged in only the work at each station.

Specifically, at the first station, the worker m1 mounts a run channel onto the standby run channel attaching apparatus X. At the time of run channel supply, an operating actuator of a portion for holding the run channel waits in a stopping state in which the holding is released. After the worker m1 has set the run channel at a specified position of the run channel attaching apparatus, the worker m1 operates an operation panel, by which the operating actuator of the holding portion is operated into a state in which holding is performed, and the subsequent automatic work is started.

During this time, the worker m2 performs the attachment of a specified component or assembly other than the run channel to the door and the sub-assembling of the assembly.

After setting the run channel onto the apparatus X, the worker m1 moves to the second station to set a regulator onto the apparatus Y. At this time, the worker m1 performs the assist conveyance from the vicinity of door to the regulator assembly attaching apparatus of door to position the regulator assembly attaching apparatus with respect to the door.

During this time, the workers m3 and m4 perform the attachment of a specified component or assembly other than the regulator to the door and the sub-assembling of the assembly.

After setting the regulator onto the apparatus X, the worker m1 moves to the third station to temporarily fix a weather strip to the door manually, and further turns on the operation switch of the apparatus Z. Specifically, the worker m1 performs the attachment of a lower part clip of the weather strip to the door, the attachment of an upper part clip, and the temporary fixing to an upper part sash. After the finish of the above-described work, the worker m1 operates the operation panel so that the weather strip attaching apparatus attaches the weather strip to the upper part sash that moves a roller while pressing the weather strip toward the groove of sash.

During this time, the worker m5 performs the attachment of a specified component or assembly other than the weather strip to the door and the sub-assembling of the assembly.

In the above-described operation, after turning on the operation switch of the apparatus Z, the worker nil can assist the other workers m2, m3, m4 and m5 in performing their work by utilizing the remaining time.

### INDUSTRIAL APPLICABILITY

A plurality of apparatuses and a human being perform work in cooperation, and at this time, the timings at which the human being intervenes are prevented from overlapping. Thereby, wasteful time can be eliminated, and the whole work can be accomplished efficiently.

1. A collaboration work system in which a human being intervenes in at least a part of work performed by a plurality of apparatuses respectively, wherein the timings at which one person intervenes in the plurality of apparatuses are set to be prevented from overlapping, so that the work is performed simultaneously by the plurality of apparatuses and at least one person.
